(19) United States
(12) Patent Application Publication
(10) Pub. No.: US 2004/0151158 A1
(43) Pub. Date: Aug. 5, 2004

(54) Method and apparatus for exchanging voice over data channels in near real time

(75) Inventors: Michel E. Gannage, Los Altos Hills, CA (US); Venkata T. Gobburu, San Jose, CA (US); Krishnakumar Narayanan, Pleasanton, CA (US)

Correspondence Address: ALTERA LAW GROUP, LLC, 6500 CITY WEST PARKWAY, SUITE 100, MINNEAPOLIS, MN, 55344-7704, US

(73) Assignee: ecrio, Inc.

(21) Appl. No.: 10/705,209

(22) Filed: Nov. 10, 2003

Related U.S. Application Data
(60) Provisional application No. 60/424,849, filed on Nov. 8, 2002.

(51) Int. Cl. H04L 12/28

(52) U.S. Cl. 370/351

(57) ABSTRACT

A notification channel based approach is used for near real time data streaming for voice. The notification channel also is used to carry small data payloads. The solution preferably includes three elements. The first element involves taking the voice input from the sender in small, digitized packets. The second element involves taking these time packets of voice data and sending them out in a sequential manner over the notification channel. At the receiving end these packets of voice data are played back through the codec supported by the platform as they are received. The third element lies in the fact that the notifications can be sent to as many recipients as required. This allows the sender to broadcast voice messages to a group of people and to implement a conference.

### CROSS-REFERENCE TO RELATED APPLICATION

This application claims the benefit of U.S. Provisional Patent Application No. 60/424,849, filed Nov. 8, 2002 (Gannage et al., “Method and apparatus for exchanging voice over data channels in near real time,” Attorney Docket No. 11547.00), which is hereby incorporated herein in its entirety by reference thereto.

### BACKGROUND OF THE INVENTION

1. Field of the Invention

The present invention relates to transfer of voice over data channels, and more particularly to the transfer of voice in near real time over networks, including wired, wireless, and hybrid networks.

2. Description of Related Art

Traditionally, voice has been transported on a network that uses circuit switching technology, while data has been transported on networks that are built with packet-switched technology. The advent of Voice over IP (Internet Protocol) with the convergence of voice and data on a single IP network is getting more and more acceptance. Today many enterprises are adopting VoIP technology in order to reduce cost with a single converged network as well as increase productivity with value added services built on unified communications platforms. The challenges of getting a good VoIP communication seem to have been resolved on fixed networks with latencies of the order of 150 ms and jitter of less than 40 ms.

On the Wireless front, VoIP technology is being implemented in 3G networks. Latencies within the network as well as within the terminals are being worked on, with the goal of achieving the same latencies and jitter as on the fixed networks. One of the first applications of VoIP on 2.5G and 3G wireless networks is the Push-to-Talk (“PTT”) application. This application allows an end user to pick up his/her mobile terminal, push a key and start talking to another mobile terminal user in real time in a walkie-talkie like manner. Push-to-Talk has been introduced by Nextel in the US on 2G circuit switch networks, and has been a very successful application. Achieving PTT on packet switched wireless networks (2.5G, 3G) with VoIP will definitely increase the capacity and thus reduce the cost of PTT communications.

Other ways of sending voice over data channels, in non real time, over wireless networks are now being introduced. Voice clips can be sent from one mobile phone to another mobile phone as an MMS (Multi-Media Service) message. MMS is a new standard that enables to send a picture, a voice clip or a video clip as an attachment to a message. The message is sent via a store and forward mechanism through an MMSC (Multi-Media Service Center) in a very similar way as email. The first MMS enabled mobile phone introduced in the market is the T68i introduced in Q2, 2002 by Ericsson. The next model, Nokia 7650 was introduced in Q3, 2002. With such a phone the user can select one of his/her friends from the contact list, record for example a 30 second voice clip and send it as an MMS message. Once the voice clip reaches the MMSC server, the recipient gets a notification that an MMS message is waiting to be downloaded. MMS voice clips are a cheap way of sending voice over data channels and the cost for an end user for sending a voice clip will soon be as cheap as an SMS.

### BRIEF SUMMARY OF THE INVENTION

While a PTT application using VoIP technology allows real time transfer of voice through streaming, it is an expensive proposition, as the deployment requires SIP (Session Initiation Protocol) infrastructure as well as the deployment of several servers on the wireless operator's network. In addition, the mobile phones supporting this infrastructure will be more expensive as they require more internal resources to be able to handle a SIP user agent as well as streaming capability.

The MMS voice clips are cheap, however they lack the real time user experience of the PTT messages. Basically, a user has to record the entire clip before sending it over as an MMS message. So the recipient of a 30 seconds voice clip, needs to wait the entire 30 seconds plus the transfer time before he or she can get a notification and subsequently start listening to the message.

These and other problems are addressed by the present invention.

One embodiment of the invention is a method of transferring audio content from a sender to a recipient in near real time, comprising: capturing segments of the audio content at predetermined intervals; respectively sending the segments at predetermined intervals as files over an IP network; receiving the files from the IP network; and recreating the audio content from the files received in the receiving step.

A further embodiment of the invention is a method of recreating continuous audio content from segments thereof captured at predetermined intervals comprising: respectively sending the segments at predetermined intervals as files over an IP network; receiving the files from the IP network; and recreating the audio content from the files received in the receiving step.

### BRIEF DESCRIPTION OF THE SEVERAL VIEWS OF THE DRAWINGS

FIG. 1 is a block schematic diagram of a voice transfer over the internet.

FIG. 2 is a block schematic diagram showing voice RTP stream packets over the IP network.

FIG. 3 is a block schematic diagram of a PTT solution implemented on a wireless 3G network including a SIP based mobile terminal FIG. 4 is a block schematic diagram of a store and forward voice clip transfer over the internet.

FIG. 5 is a block schematic diagram of a store and forward voice clip that has been divided into smaller clips of one second duration.

FIG. 6 is a block schematic diagram of a pseudo streaming of a voice message into 1 second smaller clips, in which voice message pseudo streaming and reassembly are featured.

FIG. 7 is a block schematic diagram of an ISO Layer View for voice exchanges for traditional PTT solutions.

FIG. 8 is a block schematic diagram of an ISO Layer View for voice exchanges for novel PTT solutions.

FIG. 9 is a flow diagram of a send operation of a PTT message using a novel PTT solution.

FIG. 10 is a flow diagram of a receive operation of a PTT message using a novel PTT solution.

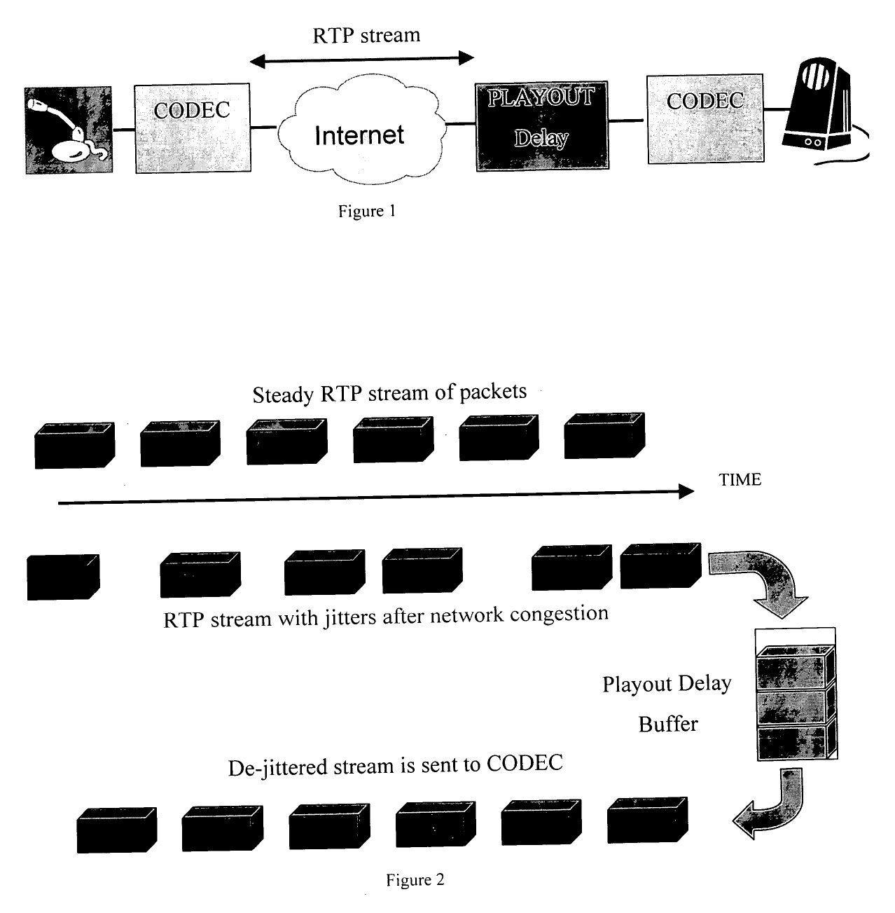

### DETAILED DESCRIPTION OF THE INVENTION, INCLUDING THE PREFERRED EMBODIMENT

Our approach is built upon the Ecrio Rich Instant Messaging Platform (“ERIMP”), which is available from Ecrio Inc. of Cupertino, Calif. The ERIMP system supports the exchange of rich messages in an Instant Messaging fashion. To accommodate client platforms that span the PC, PDA and cell phones, the ERIMP system supports peer-to-peer messaging as well as notifications based messaging. Notifications are delivered to recipients to inform them of the availability of rich messages waiting, at the ERIMP server, to be collected. Receiving clients act upon the received notification to access the ERIMP server and pick up the received message. This approach is typically classified as a “notify-get” method.

Notifications are out-of-band signals in that they occupy a totally separate channel from the main message channel. Examples of this are notifications that are established over TCP/IP sockets whereas the messages themselves are sent as HTTP traffic. The notification channel is intended to be a signaling channel and has a very fast response time. Accordingly the data payloads over the notification channel are, by definition, kept to very small values. Other example notification channels are the WAP Push and SMS.

The “notify-get” approach works well for traditional messages but proves to be too slow for content that needs to be delivered in near real time. We use a notification channel based approach for near real time data streaming for voice. Our approach uses the notification channel to also carry small data payloads. The solution preferably includes three elements.

The first element involves taking the voice input from the sender in small, digitized packets. The voice digitization techniques can either be standard approaches that are directly supported by the platform or Ecrio Inc. can provide voice codecs that can be used by both the sender as well as the receiver. For example, when sending voice from a PC or a PDA platform, one can take advantage of the built in voice digitization. The packets of voice input are composed of digitized voice samples for a defined and reasonably small value of time. An example could be the voice samples for a 5 second segment. The time period is adjustable. The time period chosen for the time packets determines the latency experienced in messaging.

The second element involves taking these time packets of voice data and sending them out in a sequential manner over the notification channel. As subsequent digitized speech samples are composed, they are sent out sequentially over the notification channel. At the receiving end these packets of voice data are played back through the codec supported by the platform as they are received. The recommended notification channel is over TCP/IP sockets. WAP Push or SMS notifications are not suitable as they have exceedingly small payloads and the latency cannot be directly controlled.

The third element lies in the fact that the notifications can be sent to as many recipients as required. This allows the sender to broadcast voice messages to a group of people. Also it allows the capability to be used to implement a conference. The capability can be derived from the basic capability of the ERIMP platform of notifications without requiring expensive media duplicators or other media resources to support conferencing.

Our approach preferably uses the basic ERIMP messaging platform at the server side and basic voice digitization and playback capabilities available at the client. The client platforms can be any of a variety of general purpose computers or special purpose appliances such as, for example, the ubiquitous PC platform, the popular PDA platforms such as the PocketPC, as well as mobile phones with J2ME and OEM extensions to give access to the voice record/playback capabilities. The mobile phones are not required to support Real Time Protocol (“RTP”), VoIP or other CPU intensive voice capabilities.

The ERIMP has the ability to detect the voice digitization and playback capabilities supported by the sender and receiving client platforms. Accordingly in cases where the sender and recipient client platforms do not both support the same voice digitization and playback codecs, it can transcode the voice messages to suit different capabilities supported between the sender client and the receiving client.

The overall experience derived by using our approach is near real time communication in which one receives a voice message with a small time lag in a pseudo streamed fashion with reasonably good quality. Advantageously, the service provider is not required to install complicated and expensive equipment to support real time streaming. In near real time communication, the audio content exchanged between the participants is delayed, but the participants may still carry on an effective conversation or other exchange of audio content. Illustratively, the delay may be greater than one second but less than ten seconds.

The audio content may be of any useful type, including voice content spoken by the sender as well as pre-created content such as jingles and music samples. Where “voice” is mentioned in the written description herein, it will be understood that the techniques described may be used with audio content in general.

FIGS. 1 & 2 describe a VoIP solution used to transfer voice over an RTP stream in today's fixed networks. The sender's voice is digitized using the codec available at the transmitting station. The voice samples are captured using an appropriate codec such as the G.711 or AMR. Each of these speech samples cover a short time period—typically in the order of about 20 ms. The speech packets are sent over the IP networks at regular intervals (i.e. 20 ms) using RTP. The RTP stream is sent using UDP as a transport layer so as to take advantage of short latency. Note the choice of UDP instead of TCP, because of the heaviness of the TCP protocol. The TCP protocol provides a more rugged way of sending data over IP with a lot of error correction and packet retransmission built-in to insure data integrity. This is not as big of a concern when voice is transported over IP, where latency is more of an issue than data integrity. The receiver does an opposite operation by taking the received UDP traffic and going through the layers to recreate the voice packet data that can be played back through the codec.

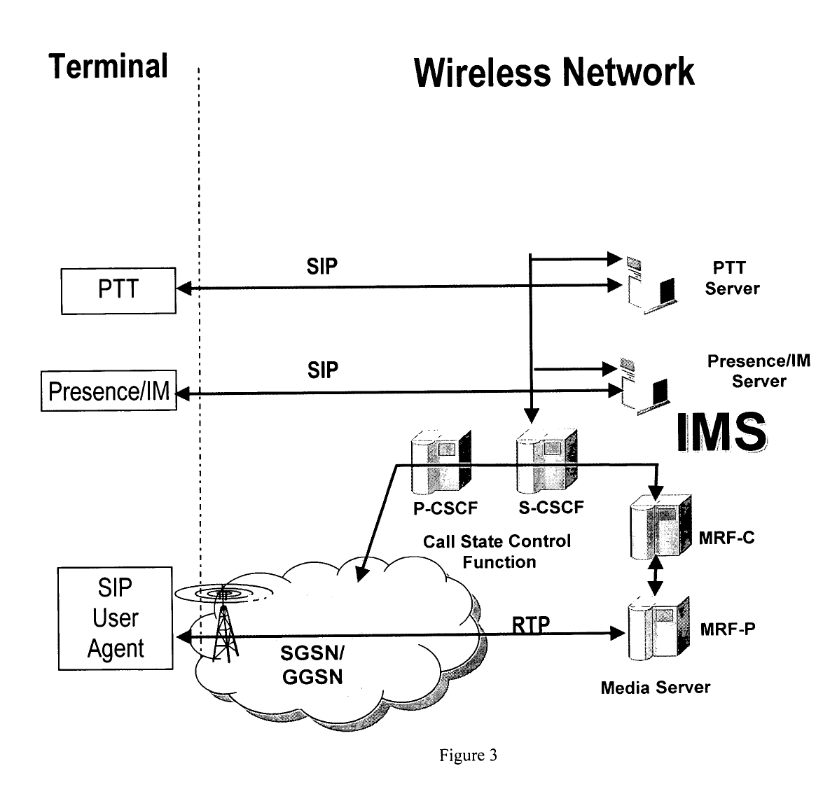

FIG. 3 describes the associated system level components that are used to manage a PTT solution in a wireless carrier's network in an IP Multi Media Subsystem environment (IMS). The solution includes components used at the server end that work in conjunction with a Session Initiation Protocol (“SIP”) enabled client (Terminal Side). The basic voice services are realized by using VoIP implementations as described above. Packetized voice is transported using RTP over UDP. The client device preferably supports SIP. In addition to the basic components used to manage voice conversations between two points, the system uses Media Resource Functions (MRF), also loosely described as media gateways or media duplicators to allow conferencing and multiple people to participate. In addition to the basic components that would be required to manage voice traffic, the figure also illustrates the elements that are required to manage the actual conference—identifying the participants, setting up and tear down of the PTT call, initiating a PTT session according to Presence, establishing floor control and finally allowing the participants a second communication channel over Instant Messaging.

FIG. 4 describes yet another option of carrying voice over a data channel in the wireless networks. MMS capable handsets offer an interesting option to enabling voice communications over data channels. The MMS handset incorporates a codec that is normally used for voice annotation—a person wishing to send an annotated picture or a personalized greeting card from the phone. The voice clip that has been recorded and saved in the record buffer can then be sent. The messaging server, after reception of the message, either sends it on directly in its entirety or notifies the intended recipient of the waiting message for later pickup.

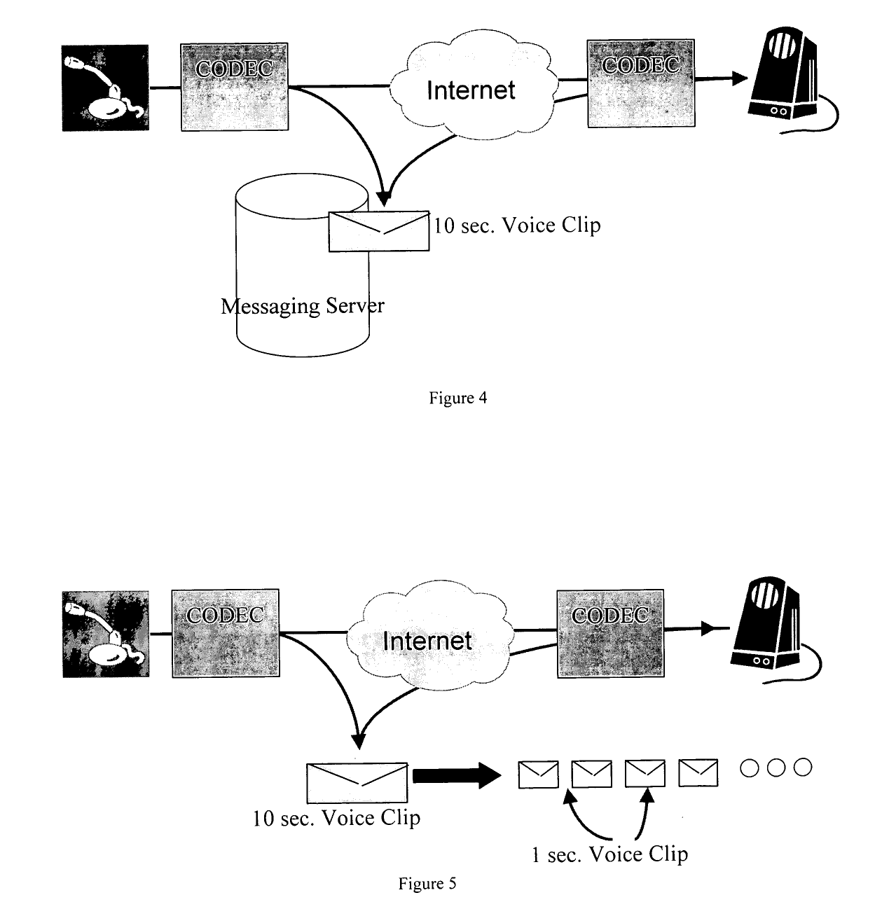

FIG. 5 illustrates a novel Push to Talk (PTT) scheme wherein the voice clip is digitized, packetized and sent out from the transmitting station. The transmitting station is shown as a microphone followed by a codec. The Ecrio PTT application addresses and sends the voice data out over the Internet. The receiving station is shown by a speaker preceded by a codec. The voice recording, in this case assumed to be a 10 second voice clip, is sent as a series of small files each managing a small time slice of the voice recording. For illustrative purposes, we use a time slice of 1 second duration. The Ecrio PTT application captures the voice recording as a series of 1 second recordings and sends them out sequentially. Each time slice recording is conceptualized as an envelope holding data file corresponding to 1 second worth of voice data. The two advantages that come out of this scheme are, first, the reduced latency to sending the voice data and, secondly, the reduced amount of memory used to implement the solution. The reduced latency comes from the fact that the application does not have to wait for the entire message to be recorded. The application can start sending out the voice message as soon as sufficient data has been accumulated. In this case, the application does not have to wait the entire 10 seconds before sending out the message but starts sending the data out as soon as a 1 second worth of voice data has been accumulated. The receiving station gets the voice data files and plays them back as they come in. This implementation does not use the RTP streaming method (sending frames of voice at regular intervals of 20 ms), which requires a heavy infrastructure both at the Wireless Network and at the handset. Instead, this implementation assembles voice packets into files every one or 2 seconds and sends the files over the IP network.

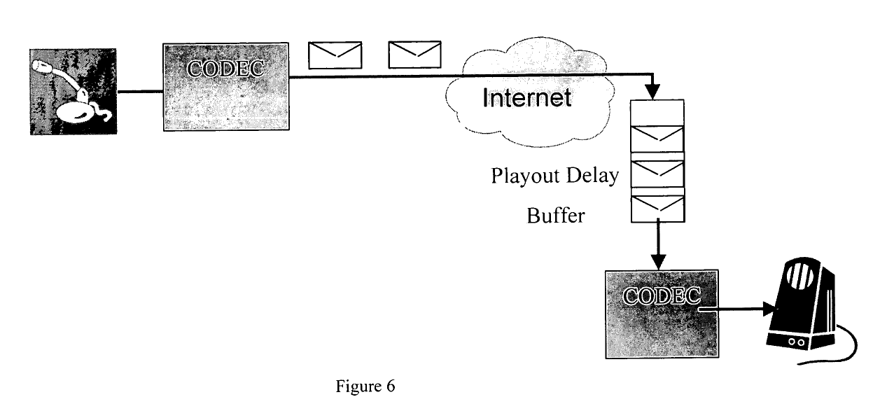

FIG. 6 illustrates a second method of implementation. The transmitting station uses the scheme as described above. The voice data files are sent out over the IP network. The IP network is not a perfect network in the sense that the transit time between the transmitter and the receiver is not always exactly the same. Consequently, voice data files from the same voice message reach the receiver with an uneven time distribution. Simply playing the voice data files as they are received could result in voice messages that have noticeable voice gaps. Ecrio's approach recommends an alternative approach—the receiving station on the other hand buffers a number of the voice data files before it starts playing them. The number of data voice files to be buffered before starting the playback can be controlled. Setting the number of voice data files received to a suitable number that is dependent upon the characteristics of the network insulates the application from varying delays in the subsequent files/packets. This approach improves the jitter immunity of the receiving station.

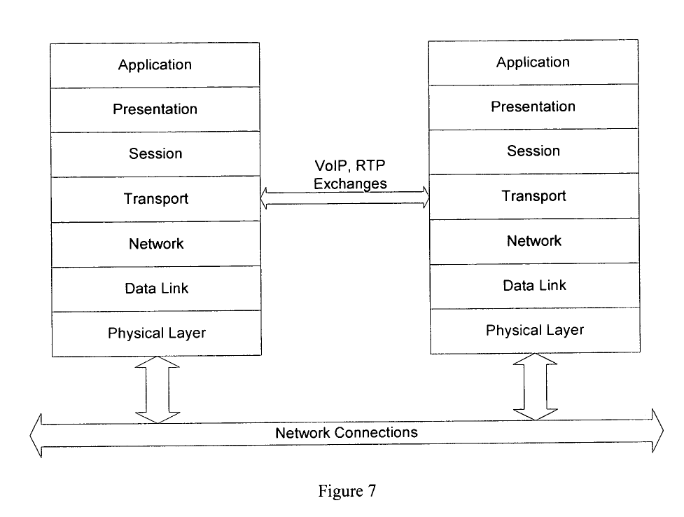

FIG. 7 illustrates the Open Systems Interconnection (“OSI”) reference model for networking protocols in conjunction with voice exchanges happening at the transport layer UDP for traditional PTT solutions. The RTP (real time protocol) protocol runs on UDP instead of TCP to allow real time streaming. In the UDP protocol data integrity is not as important as for TCP, and retransmission of lost packets are not required. It is more important to achieve low latencies even though a few packets might be lost. Latencies of less than 1 second are desirable for traditional PTT solutions.

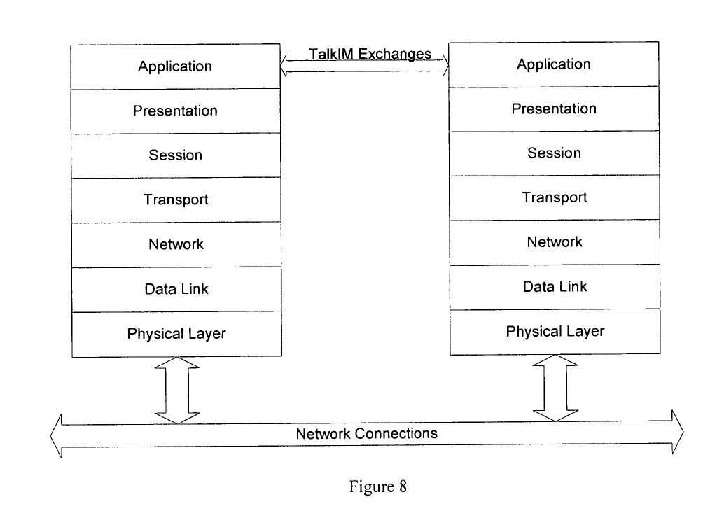

FIG. 8 illustrates a reference model for networking protocols in conjunction with voice exchanges happening at the application layer for our novel PTT solutions. Note that with this solution, latencies of less than one second might not be achievable, however 1 to 5 seconds latencies are achievable at a fraction of the cost of traditional PTT solutions. This solution can use the UDP instead of the traditional TCP transport layer when exchanging voice at the application layer for improved latencies in the network.

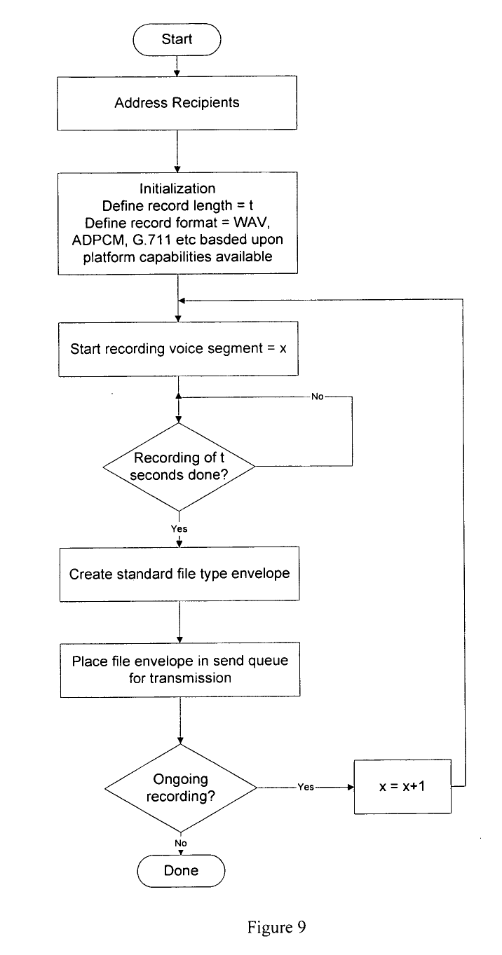

FIG. 9 illustrates a flow diagram of a send operation using our solution. Note that the recording length time t defines the latency for this PTT solution. This t time is programmable and can be controlled by the Wireless Operator depending on the congestion of its own network. This gives a simple way for the wireless operator to control the quality of service QoS.

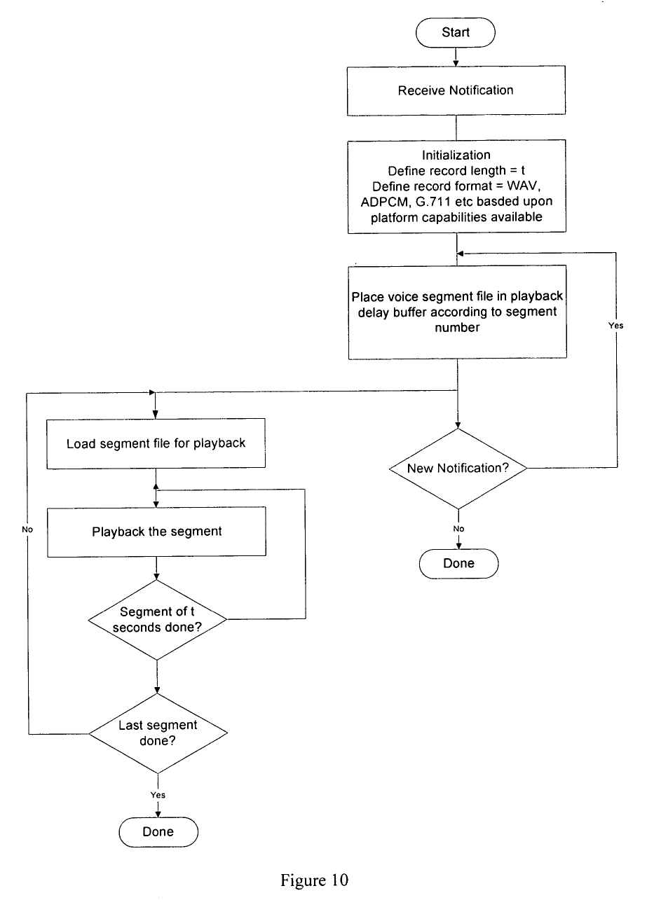

FIG. 10 illustrates a flow diagram of a receive operation using our solution. After a Notification is received, the application initializes the record length for each segment and identifies the codec used during the encoding of the voice message. It then places the voice segment in a playback delay buffer according to the segment number. After the first few segments have been received in the buffer, the segments are played back in a sequential manner until the last segment. Note that a segment x, not found in the buffer at the time of playback, is skipped over and the following segment is loaded for playback. Note also that the time between the start of playback and initial notification can be programmable as a multiple number of the segment recording time t. This gives a simple way for the wireless operator to control the Quality of Service QoS. Note also, that at the client level, if needed, transcoding can be accomplished.

What is claimed is:

1. A method of transferring voice content from a mobile terminal to a recipient in near real time as the voice content is spoken, comprising:
capturing segments of the voice content at predetermined intervals;
respectively sending the segments at predetermined intervals as files over a wireless IP-enabled network, the predetermined intervals of the sending step being respectively in near real time with the predetermined intervals of the capturing step;
receiving the files from the network; and
recreating the voice content from the files received in the receiving step.

2. The method of claim 1 wherein the sending segments step is done over a TCP connection.

3. The method of claim 2 wherein the sending segments step is done using the notification channel.

4. The method of claim 1 wherein the sending segments step is done over a UDP connection.

5. The method of claim 4 wherein the sending segments step is done using the notification channel.

6. A method of recreating continuous audio content from segments thereof captured at predetermined intervals comprising:
respectively sending the segments at predetermined intervals as files over an IP network;
receiving the files from the IP network on a mobile phone; and
recreating the voice content from the files received in the receiving step.

7. The method of claim 6 wherein the audio content comprises voice content.

8. The method of claim 6 wherein the audio content consists of voice content.

9. The method of claim 6 wherein the receiving files step is done over a TCP connection.

10. The method of claim 9 wherein the receiving files step is done using the notification channel.

11. The method of claim 6 wherein the receiving files step is done over a UDP connection.

12. The method of claim 11 wherein the receiving files step is done using the notification channel.

13. A method of placing voice content from a mobile terminal onto a network in near real time as the voice content is spoken, comprising:
capturing segments of the voice content at predetermined intervals; and
respectively sending the segments at predetermined intervals as files over a wireless IP-enabled network, the predetermined intervals of the sending step being respectively in near real time with the predetermined intervals of the capturing step.

14. The method of claim 13 wherein the sending segments step is done over a TCP connection.

15. The method of claim 14 wherein the sending segments step is done using the notification channel.

16. The method of claim 13 wherein the sending segments step is done over a UDP connection.

17. The method of claim 16 wherein the sending segments step is done using the notification channel.
